(19) United States
(12) Patent Application Publication
(10) Pub. No.: US 2012/0057295 A1
(43) Pub. Date: Mar. 8, 2012

(54) DOCKING STATION FOR A COMPUTING DEVICE

(76) Inventors: Jeffrey M. SIMPSON, Auburn, AL (US); Henry L. Raburn, Auburn, AL (US); Michael V. Raburn, Auburn, AL (US)

(21) Appl. No.: 13/225,933

(22) Filed: Sep. 6, 2011

Related U.S. Application Data
(60) Provisional application No. 61/380,853, filed on Sep. 8, 2010.

(51) Int. Cl. G06F 1/16; B23P 11/00

(52) U.S. Cl. 361/679.44; 361/679.41; 361/679.43; 29/428

(57) ABSTRACT

A docking station for an electronic device such as a tablet computer includes a docking chamber for receiving the electronic device and making electronic connection therewith, and further includes a retainer for displaying a photograph or other object when the electronic device is removed from the docking station.

### CROSS-REFERENCE TO RELATED APPLICATION

This application claims the benefit of U.S. Provisional Patent Application Ser. No. 61/380,853, filed Sep. 8, 2010, the entirety of which is hereby incorporated herein by reference for all purposes.

### TECHNICAL FIELD

The present invention relates generally to the field of electronic docking stations, and more particularly to a docking station having the general form of a picture frame for docking electronic devices and displaying images.

### BACKGROUND

The present invention relates to a multi-purpose docking station for a handheld computing device such as an iPad®, Kindle®, or other tablet computer or reader, a smartphone or other similar device.

Recently, handheld computing devices have gained in popularity. For example, one such device is known as the “iPad®,” which is a tablet style computer designed and developed by Apple, Inc. The iPad, like other similar devices, is particularly marketed as a platform for audio and visual media such as books, periodicals, movies, music, and games, as well as a platform for accessing web content. At about 700 grams (25 ounces), its size and weight are between those of most contemporary smartphones and laptop computers.

Many accessories exist to supplement standard handheld computing devices, which offer a wide range of add-on capabilities and functions. For instance, Apple, Inc. recently released an iPad docking station as an accessory to the ipad to permit easy access to a dock connector port for syncing or charging the iPad, and an audio line-out port for connecting to powered speakers via an optional audio cable. Since the release of the iPad and other handheld computing devices, aftermarket accessories have quickly flooded the market. Many of these accessories are primarily directed to carrying cases and various types of docking stations. Such products are growing in their own popularity in a gadget-based world. However, known accessories have little to no utility outside of their use as a supplement to a particular handheld device.

Accordingly, it can be seen that needs exist for handheld computing accessories that have a function and/or utility outside of being a tool for use in conjunction with a handheld device. It is to the provision of these needs and others that the present invention is primarily directed.

### SUMMARY

In example forms, the present invention provides an apparatus for docking an electronic device in which the electronic device may be inserted therein for docking and removed therefrom for use external of the docking station. When the electronic device is docked, images displayed on the display screen thereof are framed and displayed by the docking apparatus for improved visibility and/or aesthetics. When the electronic device is removed from the docking apparatus, an underlying object such as a photograph, painting or other image is framed and displayed by the docking apparatus.

In one aspect, the invention relates to a docking station for an electronic device. The docking station preferably includes a housing forming a frame at least partially surrounding a display opening. The housing preferably further defines a device receiver for removably retaining an electronic device therein with a display screen portion of the electronic device visible through the display opening. The housing preferably further includes a receptacle for retaining a displayed object positioned for visibility through the display opening when the electronic device is removed from the device receiver of the housing.

In another aspect, the invention relates to a docking station for a handheld electronic device. The docking station preferably includes a housing including a generally rectangular frame having first and second side members and first and second end members surrounding a display opening. The docking station preferably also includes a device receiver for removably retaining an electronic device therein with a display screen portion of the electronic device visible through the display opening. The docking station preferably also includes a receptacle for retaining a displayed object positioned for visibility through the display opening when the electronic device is removed from the device receiver of the housing. The docking station preferably also includes a retainer clip for securing the electronic device within the device receiver, and a removal aperture for removing the electronic device from the device receiver. The docking station preferably also includes an electronic coupling for releasable connection to the electronic device.

In still another aspect, the invention relates to a method of docking an electronic device and displaying an object. The method preferably includes alternatively docking the electronic device within a docking station wherein an electronic connection is made between the electronic device and the docking station, and removing the electronic device from the docking station to expose a displayed object positioned therein to be visible through a display opening of the docking station.

These and other aspects, features and advantages of the invention will be understood with reference to the drawing figures and detailed description herein, and will be realized by means of the various elements and combinations particularly pointed out in the appended claims. It is to be understood that both the foregoing general description and the following brief description of the drawings and detailed description of the invention are exemplary and explanatory of preferred embodiments of the invention, and are not restrictive of the invention, as claimed.

### BRIEF DESCRIPTION OF THE DRAWING FIGURES

FIG. 1 is a front view of a docking station according to a first example embodiment of the present invention.

FIG. 2 is a perspective view of the docking station of FIG. 1.

FIG. 3 is a rear view of the docking station of FIG. 1.

FIG. 4 is a side view of the docking station of FIG. 1.

FIG. 5 is an exploded perspective view of the docking station of Figure

FIG. 6 is a perspective view of the docking station of FIG. 1, shown with a photograph enclosed therein.

FIG. 7 is a front view of the docking station of FIG. 1, shown with a photograph enclosed therein.

FIG. 8 is a side view of the docking station of FIG. 1.

FIG. 9 is a perspective view of a docking station according to another example embodiment of the present invention.

FIG. 10 is an exploded assembly view of the docking station of FIG. 9.

FIG. 11 is a rear view of the docking station of FIG. 9.

FIG. 12 is a bottom end view of the docking station of FIG. 9.

### DETAILED DESCRIPTION OF THE INVENTION

The present invention may be understood more readily by reference to the following detailed description of the invention taken in connection with the accompanying drawing figures, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention. Any and all patents and other publications identified in this specification are incorporated by reference as though fully set forth herein.

Also, as used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

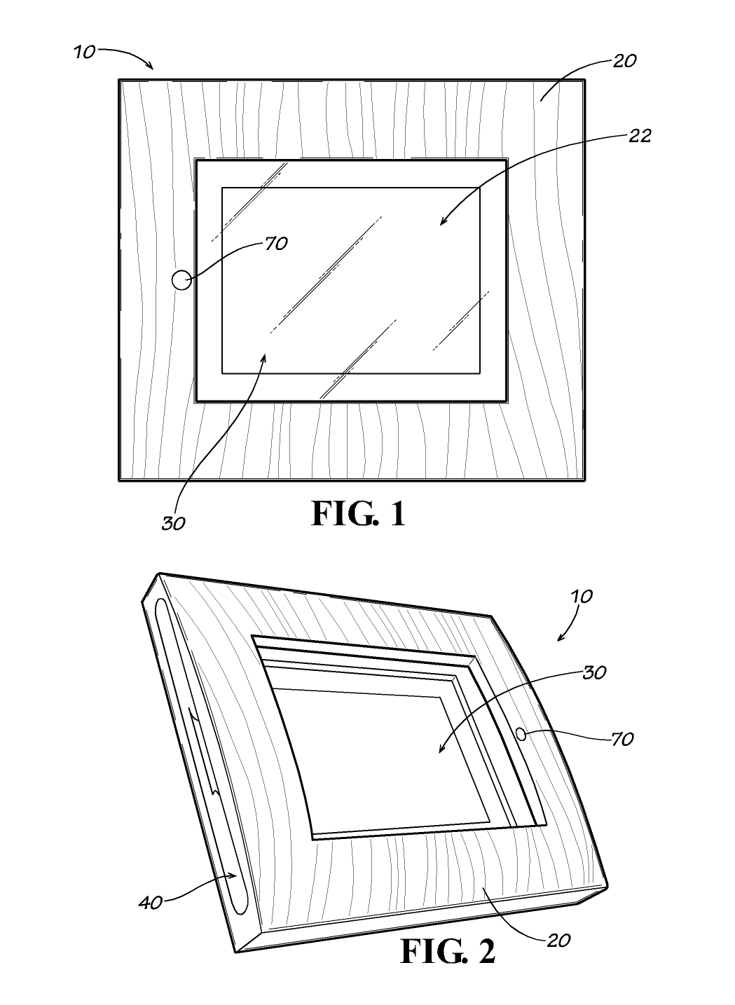

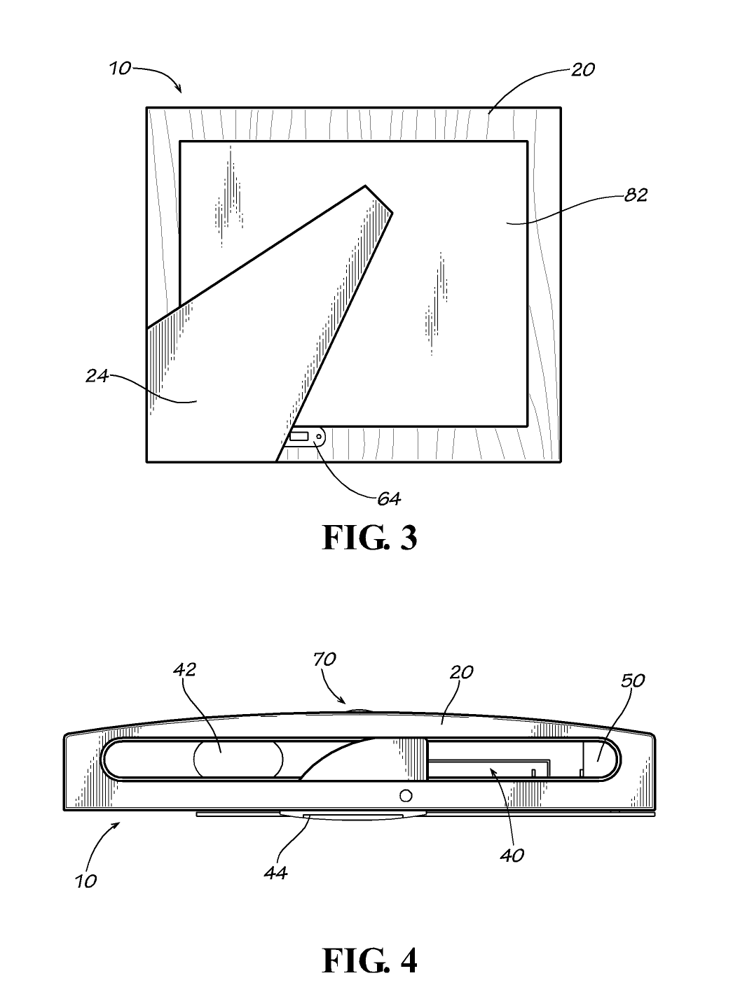

Referring now to the drawing figures, wherein like numerals represent like features, FIGS. 1-8 depict a docking station 10 according to one example embodiment in accordance with the present invention. Generally, the docking station 10 provides for a framed housing 20 that corresponds with a handheld computing device (i.e. iPad®; Kindle®; smartphone, etc.), which permits a user to selectively insert a handheld computing device into the frame to “dock” the device (e.g., store, charge, link with other devices, etc.) while providing for an aesthetically pleasing finish atypical to known docking stations. In example embodiments, the housing 20 frames out a window or display opening 22 for viewing the screen of the computing device when it is inserted into the housing. In example form, the housing 20 comprises a generally rectangular frame having first and second side rails and first and second end rails surrounding the window 22. In addition, when a user selectively removes a corresponding handheld computing device from the framed housing 20, the housing can remain viable as a frame for a picture, photograph, or other image. As such, the housing 20 includes at least one, and alternatively two or more, recesses or receptacles 30 for storing and making viewable at least one image.

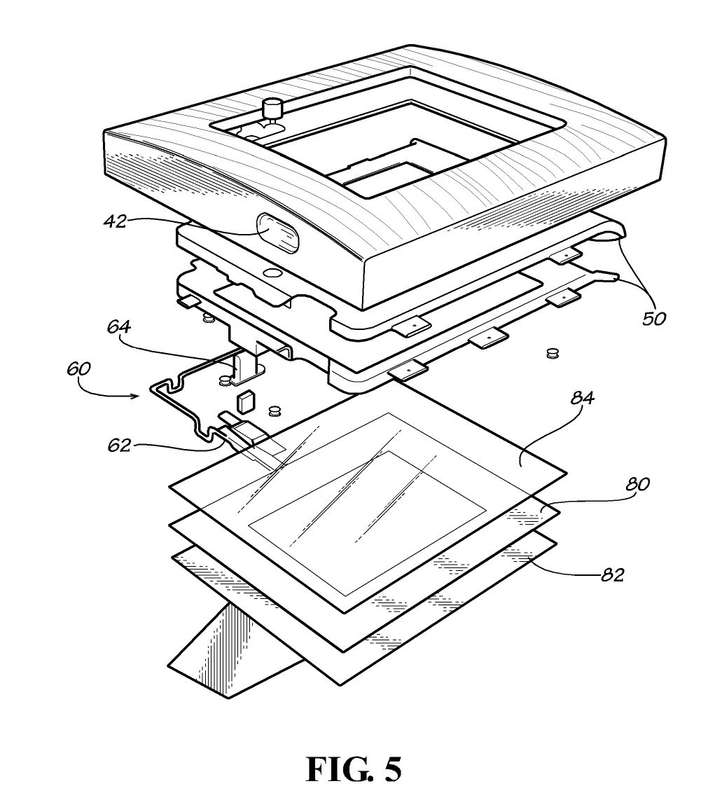

In example embodiments, the docking station 10 of the present invention also includes at least one slot or receiver 40 that extends substantially through the core of the housing 20 to define a cavity that generally corresponds to the size and shape of a complimentary handheld electronic device (not shown), such as an iPad®. In preferred embodiments, the slot or receiver 40 is substantially open on a first end to permit a user to slide a handheld device in-and-out of the housing 20—and substantially closed on a second end to provide a permanent stop surface at the end of the devices' travel within the housing. Commercial embodiments of the present invention further include at least one aperture 42 (as seen in FIG. 5) at the first end for enabling a user to use his/her finger or other implement to push the handheld computing device out of the housing 20 and at least one retaining mechanism 44 (as seen in FIG. 4) for selectively providing a temporary stop surface at the second end of the device. The retaining mechanism 44 can be a pivotal or rotating clip, snap, hook and loop fastener/strap, frictional bushing(s), or any other means operable to temporarily restrain the electronic/computing device within the housing 20.

Still further, the docking station 10 of the present invention can include a chassis 50 mounted within the slot 40 to aid in receiving a handheld device therein. The chassis can be injection molded plastic, blow-molded plastic, formed from metal and/or metal alloys, or otherwise constructed as desired. In those embodiments in which the chassis 50 is formed from one or more pieces, the chassis can be fastened together with rivets, glue, and/or other conventional fasteners.

To permit the docking station 10 of the present invention to function as traditional docking stations, the present invention can also include one or more electronic connectors operable to mate with corresponding connectors of a complimentary handheld electronic device. For instance, example embodiments can include a first connector 62 mounted within the frame in position for engagement with a corresponding connector of the electronic device to be docked therein, for connection of the docked electronic device to a power source (e.g., wall outlet, battery) to charge the handheld device (and/or performing other supplemental functions such as data transfer, depending on the particular device). In a particular embodiment, the first connector 62 is a 30-pin male connector. The first connector 62 is optionally electronically coupled to a second connector 64, such as a USB type A male plug or female port, via a USB cable or other conductor 60 extending through a channel within the housing, whereby the second connector extends externally of the housing or is attached to the housing for connection to an external power source and/or data input/output device. Optionally, the docking station 10 comprises one or more cords extending from or attachable to the connectors for connection to external power and/or data sources; and/or wireless communication means are provided for data transfer to and/or from the electronic device.

As seen in FIG. 1, the present invention can also include one or more actuators or buttons 70 for communicating with a corresponding control of the underlying handheld computing device. For example, iPads come equipped with a “home button” that permits a user to perform certain actions on the iPad. Optionally, the docking station 10 can include one or more apertures to provide access to an on/off switch, power button, front and/or rear cameras, or other control or input/output features of the underlying device.

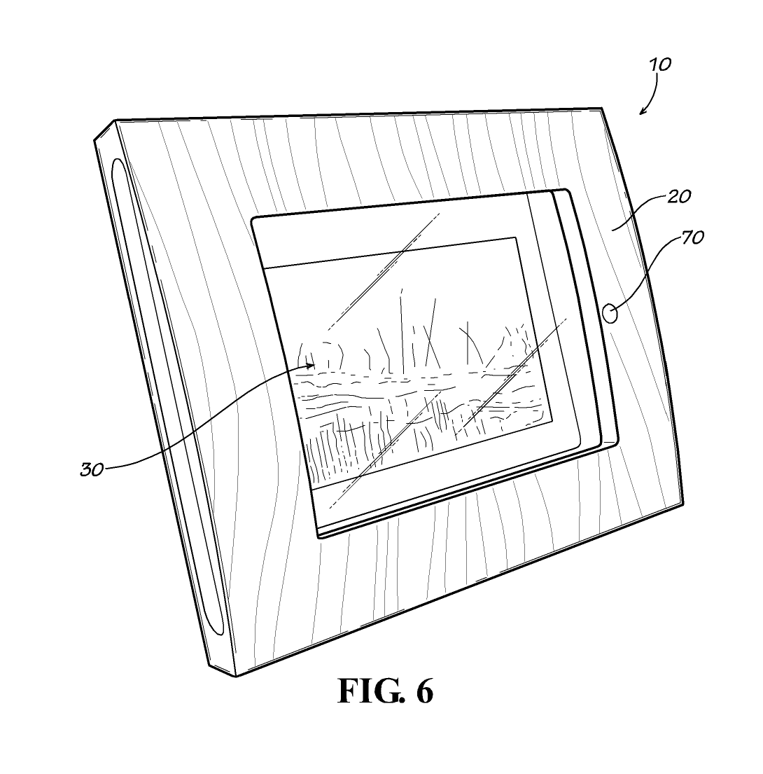

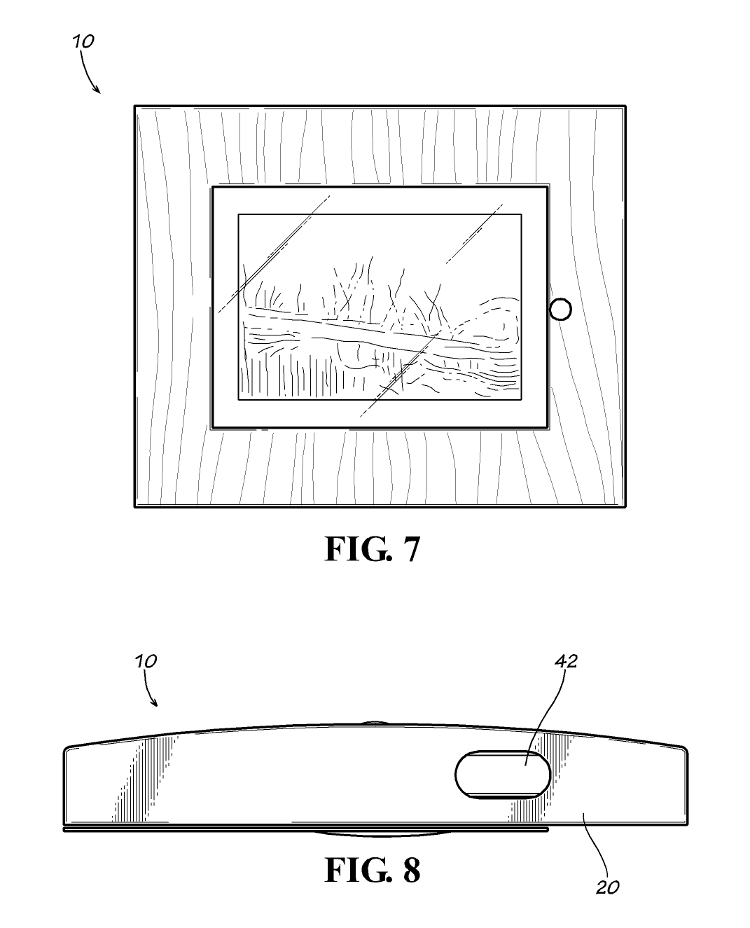

As best seen in FIG. 5, the recess 30 for storing an image is located behind the slot 40 for selectively receiving the handheld computing device. As with known picture frames, the docking station 10 can include at least one stand 24 for allowing a user to selectively position the docking station upright (either horizontally or vertically), such as an easel stand or a wire-frame stand. Optionally, the present invention can include one or more mats 80 to provide a decorative opening for surrounding the selected image. In example embodiments, at least one mat having an opening of about 5 inches by 7 inches is utilized, although in alternative embodiments larger mats or smaller mats can be employed. A removable backer board 82 can be used to allow a user access to the image recess 30 and to define a rear stop surface to secure the image therein. Optionally, a glass and/or acrylic pane 84 can be used to protect the image and to provide a front stop surface for the image. FIGS. 6-7 depict example embodiments of the present invention shown with a photograph inserted (and having no handheld computing device inserted therein).

In example embodiments, the housing 20 is formed from wood (e.g. beech wood), but can be formed from rubber, metals, plastics, etc. In example form, the dimensions of the housing are about 12 inches long×about 10 inches wide×about 1″-2″ thick, but can be varied as desired to accommodate different types of handheld computing devices, presently existing or developed in the future. The housing also can include one or more openings that correspond with a handheld devices' speakers, audio ports, multi-ports, or other features to permit user access thereto.

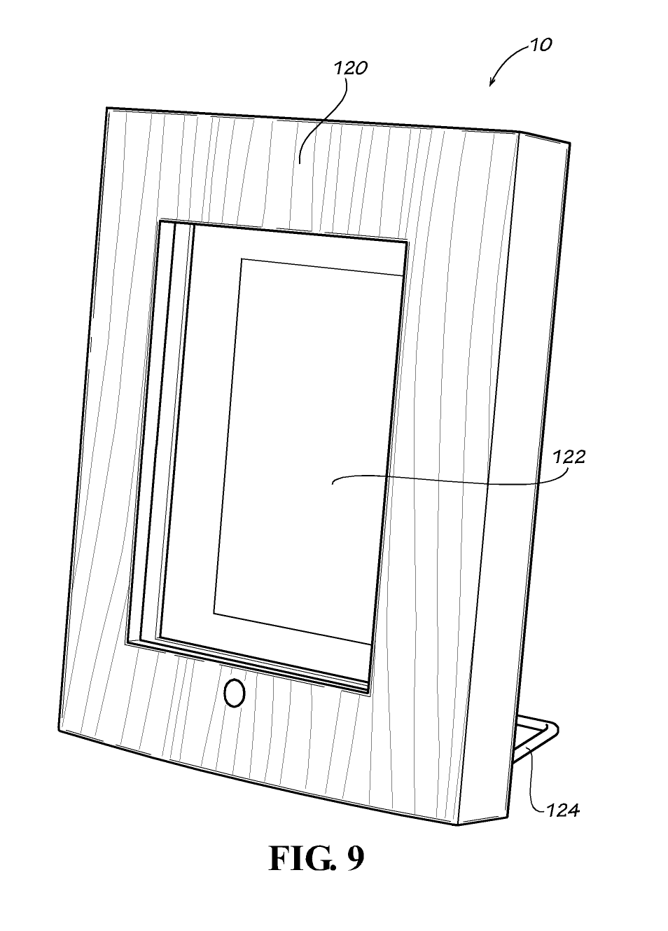

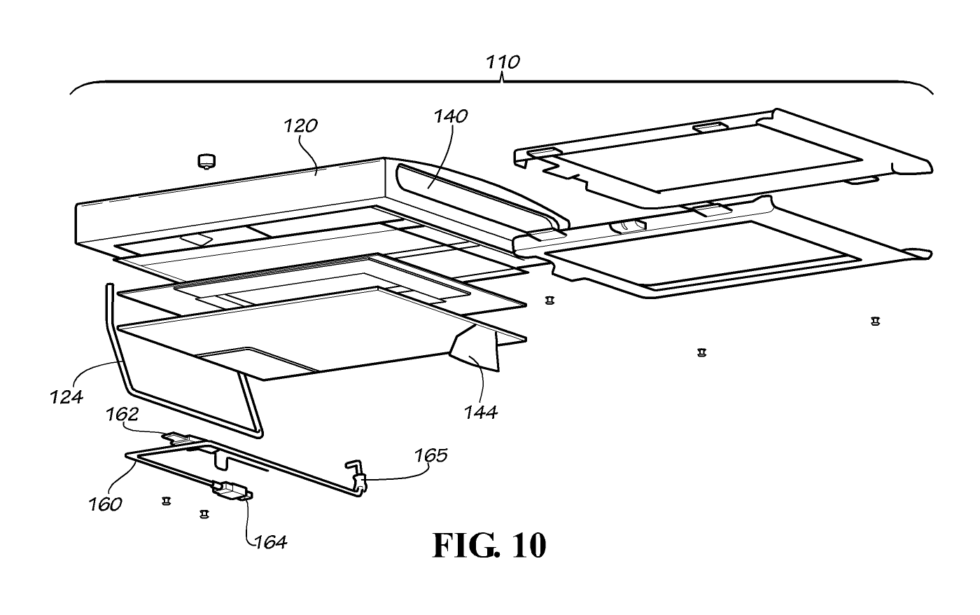

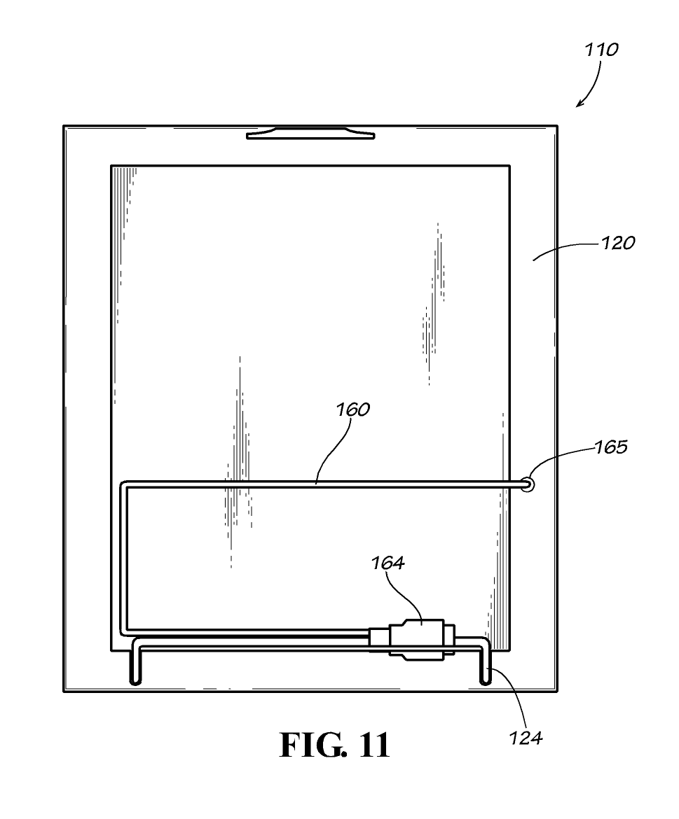

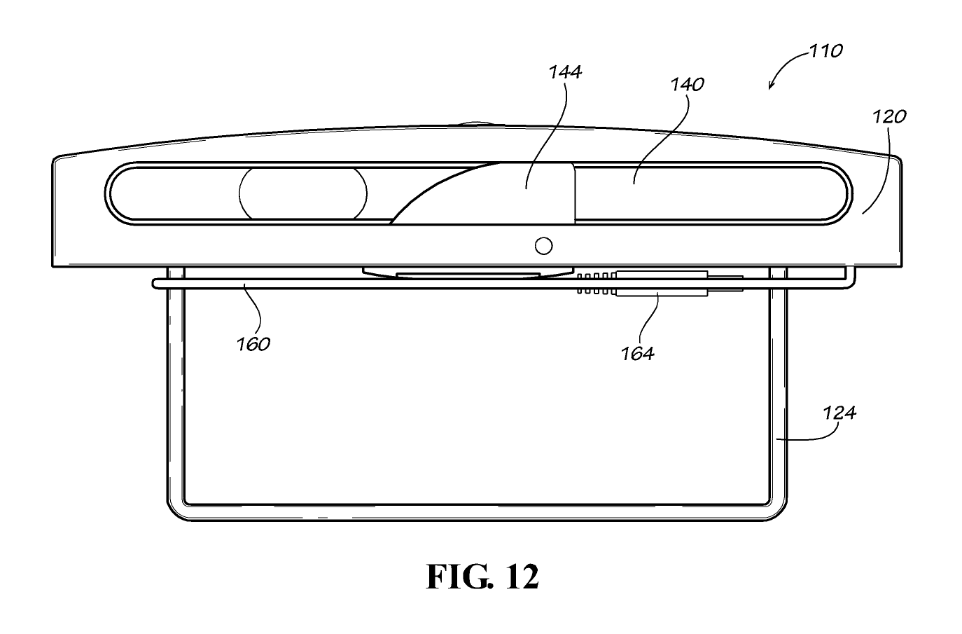

FIGS. 9-12 show another example embodiment of a docking station 110 according to the present invention. Similar to the above-described embodiment, the docking station 110 comprises a frame housing 120 surrounding a display window or opening 122. This embodiment includes a wire-frame stand 124, rather than an easel stand, for supporting the housing in a substantially upright position. A slot or receiver 140 in the housing is adapted to receive an electronic device to be docked therein, and a retaining mechanism 144 in the form of a pivotally mounted flange opens and closes access to the receiver. A cord 160 extends from a first pin connector 162 mounted within the frame, through a rear opening in the frame housing, and having a second end comprising a second connector 164 such as a USB Type A male plug. A strain relief member 165, for example in the form of a rubber or polymeric sleeve or grommet is optionally provided around the cord 160 at the frame opening. Other elements of the docking station 110 of this embodiment are substantially similar to respective elements of the above-described embodiment of docking station 10.

While the invention has been shown and described in exemplary forms, it will be apparent to those skilled in the art that many modifications, additions, and deletions can be made therein without departing from the spirit and scope of the invention as defined by the following claims.

What is claimed is:

1. A docking station for an electronic device, the docking station comprising a housing comprising a frame at least partially surrounding a display opening, the housing further defining a device receiver for removably retaining an electronic device therein with a display screen portion of the electronic device visible through the display opening, and a receptacle for retaining a displayed object positioned for visibility through the display opening when the electronic device is removed from the device receiver of the housing.

2. The docking station of claim 1, wherein the frame comprises a generally rectangular body having first and second side members and first and second end members.

3. The docking station of claim 1, wherein the device receiver comprises a slot extending through the housing and defining a cavity configured to generally conform to the electronic device's external geometry.

4. The docking station of claim 3, wherein the device receiver further comprises a chassis for receiving the electronic device.

5. The docking station of claim 4, wherein the chassis is injection molded.

6. The docking station of claim 1, further comprising a first electronic connector operable to mate with a corresponding second electronic connector of the electronic device.

7. The docking station of claim 6, wherein the first electronic connector is a 30-pin male connector.

8. The docking station of claim 6, further comprising a third electronic connector.

9. The docking station of claim 8, wherein the third electronic connector is a female USB connector.

10. The docking station of claim 1, further comprising a stand for supporting the housing in a substantially upright position.

11. The docking station of claim 10, wherein the stand is an easel stand.

12. The docking station of claim 1, further comprising at least one actuator operable through the frame to engage a corresponding control of the electronic device.

13. The docking station of claim 1, further comprising a rotating clip pivotally mounted to the housing and movable between a first position for retaining the electronic device within the housing and a second position for allowing removal of the electronic device from the housing.

14. The docking station of claim 13, further comprising a removal aperture through the housing, positioned generally opposite the rotating clip, for pushing the electronic device out of the housing when the rotating clip is in its second position.

15. The docking station of claim 1, wherein the receptacle for retaining a displayed object comprises a recess for receiving a photograph.

16. A docking station for a handheld electronic device, the docking station comprising:
a housing comprising a generally rectangular frame having first and second side members and first and second end members surrounding a display opening;
a device receiver for removably retaining an electronic device therein with a display screen portion of the electronic device visible through the display opening;
a receptacle for retaining a displayed object positioned for visibility through the display opening when the electronic device is removed from the device receiver of the housing;
a retainer clip for securing the electronic device within the device receiver;
a removal aperture for removing the electronic device from the device receiver; and
an electronic coupling for releasable connection to the electronic device.

17. The docking station of claim 16, wherein the electronic coupling comprises a 30-pin connector.

18. The docking station of claim 16, further comprising a stand for positioning the housing on a support surface.

19. The docking station of claim 16, further comprising at least one actuator operable through the frame to engage a corresponding control of the electronic device.

20. The docking station of claim 16, wherein the receptacle for retaining a displayed object comprises a recess for receiving a photograph.

21. A method of docking an electronic device and displaying an object, said method comprising alternatively docking the electronic device within a docking station wherein an electronic connection is made between the electronic device and the docking station, and removing the electronic device from the docking station to expose a displayed object positioned therein to be visible through a display opening of the docking station.
